(19) United States
(12) Patent Application Publication
(10) Pub. No.: US 2005/0204022 A1
(43) Pub. Date: Sep. 15, 2005

(54) System and method for network management XML architectural abstraction

(76) Inventors: Keith Johnston, Austin, TX (US); Mario Garcia, Austin, TX (US); Eric White, Austin, TX (US)

Correspondence Address: SPRINKLE IP LAW GROUP, 1301 W. 25TH STREET, SUITE 408, AUSTIN, TX, 78705, US

(21) Appl. No.: 11/076,672

(22) Filed: Mar. 10, 2005

Related U.S. Application Data
(60) Provisional application No. 60/551,704, filed on Mar. 10, 2004.

(51) Int. Cl. G06F 15/177; G06F 15/173

(52) U.S. Cl. 709/220; 709/223

(57) ABSTRACT

Embodiments of the present invention provide an abstraction for the representation of a network device's configuration and management data that is not tied to a particular protocol or network device implementation but is, instead, an original, general format used as source for producing multiple, alternate and/or equivalent representations that exist and occur simultaneously within a system of network devices. Other embodiments of the invention utilize XML abstraction as the input to a system of software code generators that can produce application programming interfaces used to communicate and manage network devices that support specific management protocols and representations. Another embodiment of the invention is the result of generalizing an existing, but specific, representation of a network device's configuration and management data so that the newly-generalized format can be repurposed and provide alternate, additional but equivalent representations of the original, specific network device configuration and management information.

### RELATED APPLICATIONS

This application claims priority under 35 U.S.C. 119(e) to U.S. Provisional Patent Application No. 60/551,704, entitled “SYSTEM AND METHOD FOR NETWORK MANAGEMENT XML ARCHITECTURAL ABSTRACTION,” to Keith Johnston and Mario Garcia, filed Mar. 10, 2004, which is hereby fully incorporated by reference herein.

### TECHNICAL FIELD OF THE INVENTION

Embodiments of the present invention relate to network management configuration and communication data representation. More particularly, embodiments of the present invention relate to abstracting multiple, specific forms of representing network device configuration, management and communication data such that a generalized representation can be used as a single syntactic representation of common network configuration, management and communication data elements.

### BACKGROUND

The communication of data over networks has become an important, if not essential, way for many organizations and individuals to communicate. The Internet is a global network permitting connections between millions of network client devices using a multitude of network communications protocols.

Connectivity between client devices is achieved through the use of intermediate network devices that relay, broadcast and otherwise transit client and server data for the purpose of communication. Network devices represent the endpoints of any specific segment, disregarding the transport medium (copper, fiber, wireless) of the network. In addition to millions of client devices accessing the internet, there are millions more network devices providing the internet infrastructure over which networked communications transit. It is possible that a client device can be network-enabled and act in the stead of a network-specific device; i.e., it is possible for a single device attached to a network to act both as a client and a network device, simultaneously.

Network devices exist in many different forms, formats and technologies. Network devices are capable of transiting internet traffic because of a set of protocol and signaling standards that are proposed, promoted and maintained by a small number of oversight groups that maintain a loose management of the communications and signaling protocols that facilitate the ability of the growing variety of network and client devices to communicate amongst themselves.

As network devices are endpoints of network segment, these network devices are usually configured and managed to maintain connectivity and provide a level of infrastructure to which network client devices are rarely sensitive; i.e., network client devices may interoperate with network devices at some level, but the application-level operation of network client devices typically assumes connectivity and the client network applications perform domain-specific activities under the assumption that network connectivity and resources are immutable.

Network devices take many shapes, forms and implementations and can be manufactured or provided by any kind of organization. Typically however these network devices adhere to the minimum standards prescribed for inter-operability as defined and maintained by the aforementioned standards bodies.

The configuration of network devices themselves, and the manner in which remote configuration and management of these network devices is achieved, is also addressed by a small number of standards. These network device management and configuration standards are not unilaterally supported by all network device implementations and there are a diversity of implementations, configurations and management dialects amongst the worldwide population of network devices.

An organization wishing to manage and configure a network comprised of network segments and their device endpoints usually must understand the dialect and capabilities of each network device in order to maintain and evolve the network infrastructure that these devices comprise.

It is possible to acquire all network devices from a single source and, therefore, rely upon device homogeneity as a means for ensuring configuration and management consistency.

It is more likely however that, over time, any organization's network, and the devices comprising it, will diverge from a single-source for network devices and the network infrastructure will become populated by a heterogeneous mix of network devices.

The case where heterogeneous network devices exist as endpoints of network segments and the population of those devices presents a growing problem.

### SUMMARY OF THE INVENTION

Embodiments of the present invention provide systems and methods of providing network device management that eliminates, or substantially reduces, the complexity of configuring and managing a heterogeneous mix of network devices. More particularly, one embodiment of the present invention defines an origin for defining network device configuration or management data. In one embodiment of the present invention, the original source of network device configuration and management data is used as a data dictionary, from which multiple simultaneous computer code implementations may be generated in order to support configuring and managing multiple, heterogeneous network devices.

Another embodiment of the present invention can use a single data dictionary for network device configuration and management to generate another form of data dictionary, as specified by a network community standard. The single, original configuration and management data dictionary can be defined using one form of syntax and technology, which is used as a source for a translator to a completely different syntax and technology representation. In one embodiment, extended markup language (XML) is used as the syntax for the original network device configuration and management data dictionary and from that XML representation, multiple alternate syntax and formats (e.g., Simple Network Management Protocol Management Information Base) can be produced, via a translator.

Another embodiment of the invention can take an existing data dictionary representation of network device configuration and management data and translate this original representation into an abstracted representation that can then be used to re-translate into representations of the original data in different syntaxes with differing technologies. In one embodiment, an original, specific syntax (e.g., Simple Network Management Protocol Management Information Base—a textual, formatted representation) can be generalized into an extended markup language (XML) format.

Another embodiment of the invention involves the analysis of multiple, disparate network device configuration and management data dictionaries and schemas, resulting in a generalized abstraction of all specific parts and the collection of those generalized abstractions into a single, general data dictionary schema.

Another embodiment of the invention may be utilized in conjunction with a software code generator; automatically producing a specific form and syntax for network device configuration and management, and augmenting the abstracted notation for data representation with annotations that assist the software code generator through optimal data typing and data structure indicators.

In one embodiment, an XML schema that describes the configuration data of the system is created. The XML schema is generated from the SNMP MIB. The operations on this data may be simple and are derived from the operations permitted by SNMP—the data is arranged into tables and groups of related values.

Embodiments of the present invention may present the advantage is that multiple management protocols for a given device can be supported without having to maintain by hand the layers of code to connect the protocol engine to a configuration API. New protocols can be supported by writing the code generator for the new protocol and using the existing XML Schema to drive the code generator to produce the layers for the new protocol.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of a system for providing a data dictionary.

FIG. 2 is a diagrammatic representation of a system for providing a translation path from a specific network device configuration and management data dictionary to a general one.

### DETAILED DESCRIPTION

The following applications are hereby fully incorporated by reference herein in their entirety: U.S. application Ser. No. 10/683,317, filed Oct. 10, 2003 entitled “SYSTEM AND METHOD FOR PROVIDING ACCESS CONTROL,” by Richard MacKinnon, Kelly Looney, and Eric White; U.S. Provisional Application No. 60/551,698, filed Mar. 10, 2004 entitled “SYSTEM AND METHOD FOR BEHAVIOR-BASED FIREWALL MODELING,” by Patrick Turley which converted into U.S. application Ser. No. 10/______, filed Mar. 10, 2005 entitled “SYSTEM AND METHOD FOR BEHAVIOR-BASED FIREWALL MODELING,” by Richard MacKinnon, Kelly Looney, and Eric White; U.S. Provisional Application No. 60/551,754, filed Mar. 10, 2004 entitled “SYSTEM AND METHOD FOR COMPREHENSIVE CODE GENERATION FOR SYSTEM MANAGEMENT,” by Keith Johnston which converted into U.S. application Ser. No. 10/______, filed Mar. 10, 2005 entitled “SYSTEM AND METHOD FOR COMPREHENSIVE CODE GENERATION FOR SYSTEM MANAGEMENT,” by Keith Johnston; U.S. Provisional Application No. 60/551,703, filed Mar. 10, 2004 entitled “SYSTEM AND METHOD FOR PROVIDING A CENTRALIZED DESCRIPTION/CONFIGURATION OF CLIENT DEVICES ON A NETWORK ACCESS GATEWAY,” by Patrick Turley and Keith Johnston; U.S. Provisional Application No. 60/551,702, filed Mar. 10, 2004 entitled “SYSTEM AND METHOD FOR ACCESS SCOPE CONTROL (“WALLED GARDENS”) FOR CLIENTS OF A NETWORK ACCESS GATEWAY,” by Patrick Turley, Keith Johnston, and Steven D. Tonnesen which converted into U.S. application Ser. No. 10/______, filed Mar. 10, 2005 entitled “METHOD AND SYSTEM FOR CONTROLLING NETWORK ACCESS,” by Patrick Turley, Keith Johnston, and Steven D. Tonnesen; U.S. Provisional Application No. 60/551,699, filed Mar. 10, 2004 entitled “SYSTEM AND METHOD FOR DYNAMIC BANDWIDTH CONTROL,” by Patrick Turley, et al.; U.S. Provisional Application No. 60/551,697, filed Mar. 10, 2004 entitled “SYSTEM AND METHOD FOR DETECTION OF ABERRANT NETWORK BEHAVIOR BY CLIENTS OF A NETWORK ACCESS GATEWAY,” by Steven D. Tonnesen which converted into U.S. application Ser. No. 10/______, filed Mar. 10, 2005 entitled “SYSTEM AND METHOD FOR DETECTION OF ABERRANT NETWORK BEHAVIOR BY CLIENTS OF A NETWORK ACCESS GATEWAY,” by Steven D. Tonnesen; U.S. Provisional Application No. 60/551,705, filed Mar. 10, 2004 entitled “SYSTEM AND METHOD FOR DOUBLE-CAPTURE/DOUBLE-REDIRECT TO A DIFFERENT LOCATION,” by Keith Johnston, et al. which converted into U.S. application Ser. No. 10/______, filed Mar. 10, 2005 entitled “SYSTEM AND METHOD FOR DOUBLE-CAPTURE/DOUBLE-REDIRECT TO A DIFFERENT LOCATION,” by Keith Johnston, et al.; U.S. Provisional Application No. 60/551,704, filed Mar. 10, 2004 entitled “SYSTEM AND METHOD FOR NETWORK MANAGEMENT XML ARCHITECTURAL ABSTRACTION,” by Keith Johnston and Mario Garcia which converted into U.S. application Ser. No. 10/______, filed Mar. 10, 2005 entitled “SYSTEM AND METHOD FOR NETWORK MANAGEMENT XML ARCHITECTURAL ABSTRACTION,” by Keith Johnston and Mario Garcia; and United States Provisional Application No. 60/______, filed Mar. 10, 2005 entitled “SYSTEM AND METHOD FOR PROVIDING A CENTRALIZED DESCRIPTION/CONFIGURATION OF CLIENT DEVICES ON A NETWORK ACCESS GATEWORK,” by Patrick Turley, et al.

Preferred embodiments of the invention are illustrated in the FIGURES, like numerals being used to refer to like and corresponding parts of the various drawings.

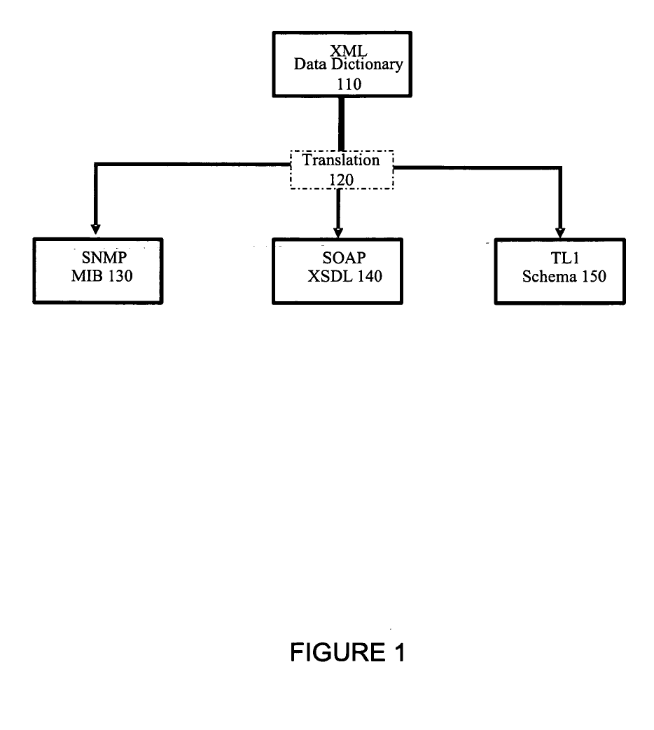

FIG. 1 presents one embodiment of a system for the creation of a data dictionary. In one embodiment, the system can provide an original, abstracted data dictionary for a network device's configuration and management data and the possible alternate representations of the same network device configuration and management data that can result when the original, abstracted syntax is translated in multiple, simultaneous representations of that data, using different syntax, notations and technology.

FIG. 1 presents a representation of an XML schema such as that listed in the Appendix employed to create an XML data dictionary of the configuration and management data of any given network device. Said differently, in FIG. 1, box 110 labeled “XML Data Dictionary” represents a generalized representation of a device's configuration and management data and conforms to an XML schema similar or identical to that presented in the Appendix. FIG. 1 illustrates a “Translation” process as represented by dotted-line box 120 and the end results of such a process, multiple representations of the network device's configuration and management data, as indicated by boxes 130, 140, 150 labeled “SNMP MIB”, “SOAP XSDL”, and “TL1 Schema” respectively. In FIG. 1, box 130 labeled “SNMP MIB” refers to the syntax and structure of the Simple Network Management Protocol Management Information Base, which is a textual, formatted representation of network management data. SNMP MIB's are often produced for network devices as a manner of describing the available configuration and management data for that device. The 140 box labeled “SOAP XSDL” refers to the Simple Object Access Protocol XML Schema-Description Language, which is an XML syntax for describing structured (XML) text data communicated over a network. XSDL files are typically used as input to a code generator that produces a resultant Application Programming Interface (API) for receiving and sending the data described in the XSDL file. In the “SOAP XSDL” case, a new form of the original XML data to be used for remote management and configuration of a device supporting a SOAP XSDL interface is produced. In FIG. 1, box 150 labeled “TL1 Schema” represents to the schema used by the TL1 communications protocol, which is prevalent in the telecommunications industry; i.e., pre-dating the internet and pervasive network-protocols, the telecommunications industry (primarily voice-data) employed protocols for managing their network devices. TL1 is also a formatted, textual format. In FIG. 1, “Translation” box 120 represents any process that can read, parse and understand the XML syntax of the original data dictionary (“XML” box 110) and produce the formats indicated by the “SNMP MIB”, “SOAP XSDL” and “TL1 Schema” boxes 130, 140, 150. FIG. 1 represents one example of a single XML network device data dictionary used to produce multiple different, but functionally-equivalent representations using different technology. Any alternate device configuration and management representation can be achieved and the invention is not limited to the output formats listed in FIG. 1.

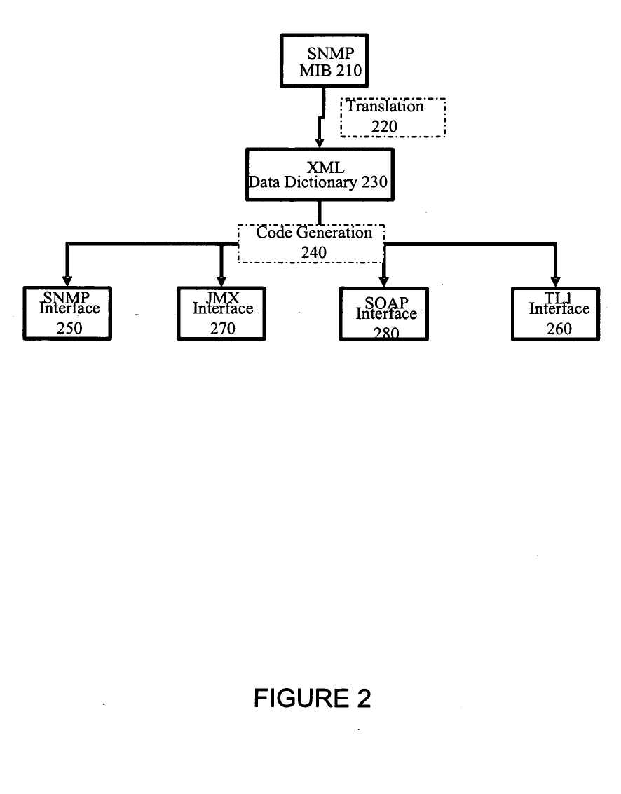

FIG. 2 represents one embodiment of the present invention where an original network device's configuration and management data is available via a specific schema or data dictionary. In one embodiment, a system may provide a translation path from a specific network device configuration and management data dictionary (SNMP MIB) to a general one (XML) and subsequently to other, specific data dictionaries and their software application interfaces resulting from code generation.

In this case, the network device's configuration and management data is published as a Simple Network Management Protocol Management Information Base (box 210 labeled, “SNMP MIB”). It is common that a network device producer will publish the manner in which a device can be configured and managed. Use of the SNMP MIB format is a common, though not exclusive practice; i.e., it is also possible to obtain or publish a network device's configuration and management data in other formats (e.g., “SOAP XSDL”, “TL1 Schema”, etc.). In one embodiment a process moves from a specific network device data dictionary to a general one. The general network device configuration and management schema and the process of producing that schema are separate embodiments of this invention. Dotted-notation box 220 labeled “Translation” indicates a process by which the original, specific data dictionary is read, parsed and understood and then reformatted and produced as an XML representation of the same information, equivalent in function and information content, but different in format (XML data dictionary box 230. The “Translation” process (box 220) may utilize must have knowledge of both the original, specific input format and schema rules required to produce the general, abstract XML format. More specifically, the output XML format may adhere to an XML schema that is substantially identical or equivalent to that listed in the appendix. From the resultant XML format data dictionary (box 230) a next stage (code generation box 240) can occur where the general XML format is used to code-generate Application Programming Interfaces (API's) in a variety of software programming languages that conform to the communications and data transfer requirements of network devices supporting different protocols. In FIG. 2 these multiple, simultaneous formats are depicted with boxes 250, 260, 270, 280 labeled “SNMP INTERFACE”, “TL1 INTERFACE”, “JMX INTERFACE”, and “SOAP INTERFACE” respectively. In one embodiment, these interfaces may be APIs. Generated code resulting in the SNMP API (box 250) may employ the Universal Datagram Protocol (UDP) and communicate with an SNMP-enabled device using the application-layer protocol defined by the Simple Network Management Protocol. Generated code resulting in the TL1 API (box 260) may employ the TL1 protocol to communicate with a TL1-enabled network device. Generated code resulting in the JMX API (box 260) may employ the Java Remote Method Protocol to communicate network device configuration and management data to a JMX-enabled device. Generated code resulting in the SOAP API (box 270) may employ the Hypertext Transfer Protocol to communicate configuration and management data to a network device enabled for SOAP management and configuration. While FIG. 2 depicts 4 resulting API's (SNMP, TL1, SOAP, JMX) as representative examples. It will be understood that a broader set of possible APIs can be code generated from the general XML network device configuration and management data dictionary (box 230).

Appendix

This Appendix presents an example data dictionary schema resulting from the application of one embodiment of this invention. The schema representation employs extended markup language (XML) and is an optimal representation of a general network device configuration and management data schema.

This Appendix lists an example of an XML schema for abstracting network device configuration and management data. This XML schema is also annotated with elements that facilitate the generation of Java software codes, if a code generator was employed to produce alternate configuration and management representations or application programming interfaces for Java. Other embodiments of this invention can extend this XML schema to include annotations for other programming language codes. From a network device data dictionary perspective, this listing is optimized to abstract specific data element types and constructs such that this XML schema could represent data elements derived from a multitude of original, specific network device configuration and management data schemas.

<xsd:schema jaxb:version=“1.0” xmlns:xsd=“http://www.w3.org/2001 /XMLSchema”
xmlns:jaxb=“http://java.sun.com/xml/ns/jaxb”>
<!--

| | == | Mapping of schema types to other formats. (RO = Read-only) | | | | | |
|---|---|---|---|---|---|---|---|
| | == | | | | | | |
| | == | | | | | | |
| | == | Schema Type | RO | SNMP Type | XSD Type | Java Type | TJDO |
| Type | | | | | | | |
| | == | =========== | == | ========= | ======== | ========= | |

=========

| | | | | | | | |
|---|---|---|---|---|---|---|---|
| | == | boolean | N | TruthValue | xsd:boolean | boolean | Char |
| (Y/N) | | | | | | | |
| | == | string | N | OCTET STRING | xsd:string | java.lang.String | |
| | == | integer | N | Integer32 | xsd:int | int | |
| | == | ipaddress | N | IpAddress | xsd:string | java.net.InetAddress | |
| | == | bignum | Y | Counter64 | xsd:integer | java.math.BigInteger | |
| | == | enum | N | INTEGER | xsd:string | code-generated class | |
| | == | | | | | | |
| | --> | | | | | | |

```
  <xsd:simpleType name=“configBaseType” >
      <xsd:restriction base =“xsd:NCName” >
        <xsd:enumeration value=“boolean” />
        <xsd:enumeration value=“string” />
        <xsd:enumeration value=“integer” />
        <xsd:enumeration value=“ipaddress” />
        <xsd:enumeration value=“bignum” />
        <xsd:enumeration value=“enum” />
      </xsd:restriction>
  </xsd:simpleType>
    <!--
      ==  An enumerated type is a sequence of strings. The order of the
      ==  strings determines the SNMP integer value assigned to each
      ==  string value. The first value will always map to ‘1’.
      -->
  <xsd:complexType name=“configEnum” >
        <xsd:sequence>
          <xsd:element name=“enumValue” type=“xsd:string” minOccurs=“1”
maxOccurs=“unbounded” />
        </xsd:sequence>
  </xsd:complexType>
  <!--
    ==  The mibInfoType XML block allows MIB-specific information to be added
    ==  to the config schema.
    ==
    ==  header: the text in the header is directly added to the top of the MIB
    ==  groupNode: the name of the parent node of admin groups (notification group,
object groups)
    ==  topNode: the name of the default parent group for tables and groups in the
XML
    ==  topOid: the top oid below which groups and tables are located by default
    ==  trapNode: the name of the node below which traps are located
    ==  trapOid: the trap oid below which traps are located
    -->
  <xsd:complexType name=“mibInfoType” >
        <xsd:sequence>
          <xsd:element name=“header” type=“xsd:string” minOccurs=“1” maxOccurs=“1”/>
          <xsd:element name=“groupNode” type=“xsd:string” minOccurs=“1”
maxOccurs=“1”/>
          <xsd:element name=“topNode” type=“xsd:string” minOccurs=“1”
maxOccurs=“1”/>
          <xsd:element name=“topOid” type=“xsd:string” minOccurs=“1” maxOccurs=“1”/>
          <xsd:element name=“trapNode” type=“xsd:string” minOccurs=“1”
maxOccurs=“1”/>
          <xsd:element name=“trapOid” type=“xsd:string” minOccurs=“1”
maxOccurs=“1”/>
        </xsd:sequence>
  </xsd:complexType>
  <!--
    ==  New types can be defined in the XML. Currently only strings, integers,
    ==  and enumerated types can be defined.
    ==
    ==  name: The name of the type
    ==  description: Description of the type
    ==  baseType: The base type that the new type derives from (integer, string, enum
are supported)
    ==  enumValues: The list of enumerated values for the type if it derives from
enum
    ==  length: This attribute applies only to types derived from strings. Specifies
the
    ==  maximum length of the string.
    ==  isEncrypted: This attribute applies only to types derived from strings. If
true,
    ==  then the string should be encrypted.
    == min: This attribute applies only to types derived from integers. Specifies
the minimum
    ==  value of the integer.
    ==  max: This attribute applies only to types derived from integers. Specifies
the maximum
    ==  value of the integer.
    ==  inMib: If true, then this type should be in the code-generated MIB. This is
used
    ==  to define types like RowStatus, for which we need a code-generated
enum type,
    ==  but we do not need to define it in the MIB, since it is in another MIB
already.
  -->
  <xsd:complexType name=“configType” >
      <xsd:sequence>
          <xsd:element name=“name” type=“xsd:string” minOccurs=“1” maxOccurs=“1” />
          <xsd:element name=“description” type=“xsd:string” minOccurs=“0”
maxOccurs=“1”/>
          <xsd:element name=“baseType” type=“configBaseType” minOccurs=“1”
maxOccurs=“1 />
          <xsd:element name=“enumValues” type=“configEnum” minOccurs=“0”
maxOccurs=“1” />
      </xsd:sequence>
      <xsd:attribute name=“length” type=“xsd:int” />
      <xsd:attribute name=“isEncrypted” type=“xsd:boolean” default=“false”/>
      <xsd:attribute name=“min” type=“xsd:string” />
      <xsd:attribute name=“max” type=“xsd:string” />
      <xsd:attribute name=“inMib” type=“xsd:boolean” default=“true” />
  </xsd:complexType>
    <!--
    ==  Variables are contained in groups and in tables (where they appear as
columns).
    ==
    == name: The name of the variable
    == description: description of the variable
    == type: Either the configType or the baseType of the variable.
    == defaultValue: the default value of the variable if no value is specified
    == oid: the last part of the oid for this variable
    == snmpReadOnly: This variable should have read-only access in the MIB. By
default,
    ==  variables are read-write or read-create (in tables that allow
creation)
    ==  snmpStatus: The default status is “current”. If a variable is no longer
used, the
    ==  snmpType should be “obsolete”.
    ==  isIndex: Set to true if the variable is a column in a table and is part of
the index
    ==  parent: This should always be empty - it is used internally
    ==  snmpType: This is used to set the actual SNMP type (like TestAndIncr),
instead of the
    ==  default type implied by the variable type
  -->
  <xsd :complexType name=“configVariable” >
      <xsd:sequence>
          <xsd:element name=“name” type=“xsd:string” minOccurs=“1” maxOccurs=“1” />
          <xsd:element name=“description” type=“xsd:string” minOccurs=“0”
maxOccurs=“1”/>
          <xsd:element name=“type” type=“xsd:string” minOccurs=“1” maxOccurs=“1” />
          <xsd:element name=“defaultVal” type=“xsd:string” minOccurs=“0”
maxOccurs=“1” />
      </xsd:sequence>
      <xsd:attribute name=“oid” type=“xsd:string” />
      <xsd:attribute name=“snmpReadOnly” type=“xsd:boolean” />
      <xsd:attribute name=“snmpStatus” type=“xsd:string” />
      <xsd:attribute name=“isIndex” type=“xsd:boolean” />
      <xsd:attribute name=“parent” type=“xsd:string” />
      <xsd:attribute name=“snmpType” type=“xsd:string” />
  </xsd:complexType>
  <!--
    ==  A group can contain variables, or no variables if it represents a node
    ==  in the MIB that contains other groups or tables.
    ==
    ==  name: The name of the group
    ==  description: description of the group
    ==  variable: A list of variables in the group
    ==  oid: the last part of the oid for this group
    ==  parent: The name of the parent node for this group. If empty, it will be the
topNode
    ==  specified in the mibInfo
    ==  isSnmpOnly: If true, this group will not have persistence classes generated.
    ==  snmpClassname: Custom-implemented snmp groups will by default have the
classname
    ==  of Rsn<groupname>Group. If the name of the group needs to be
    ==  different from this default name, you can override it with
this attribute.
  -->
  <xsd:complexType name=“configGroup” >
      <xsd:sequence>
          <xsd:element name=“name” type=“xsd:string” minOccurs=“1” maxOccurs=“1”/>
          <xsd:element name=“description” type=“xsd:string” minOccurs=“0”
maxOccurs=“1”/>
          <xsd:element name=“variable” type=“configVariable” minOccurs=“0”
maxOccurs=“unbounded” />
      </xsd:sequence>
      <xsd:attribute name=“oid” type=“xsd:string” />
      <xsd:attribute name=“parent” type=“xsd:string” />
      <xsd:attribute name=“isSnmpOnly” type=“xsd:boolean” />
      <xsd:attribute name=“snmpClassname” type=“xsd:string” />
  </xsd:complexType>
  <!--
    ==  A table must contain one or more columns. If a table has a column with
    ==  type RowStatus, then the columns will be read-create. Otherwise they will
    ==  be read-write, unless specified to be readOnly by the snmpReadOnly attribute.
    ==
    ==  A column is defined by the variable schema type.
    ==
    ==  name: The name of the table
    ==  description: description of the table
    ==  column: A list of columns in the table
    ==  oid: the last part of the oid for this table
    ==  parent: The name of the parent node for this table. If empty, it will be the
topNode
    ==  specified in the mibInfo
    ==  isSnmpOnly: If true, this group will not have persistence classes generated.
    ==  snmpStatus: The default status is “current”. If a variable is no longer
used, the
    ==  snmpType should be “obsolete”.
    ==  snmpClassname: Custom-implemented snmp groups will by default have the
classname
    ==  of Rsn<tablename>. If the name of the group needs to be
    ==  different from this default name, you can override it with
this attribute.
  -->
  <xsd:complexType name=“configTable” >
      <xsd:sequence>
            <xsd:element name=“name” type=“xsd:string” />
            <xsd:element name=“description” type=“xsd:string” minOccurs=“0”
maxOccurs=“1”/>
            <xsd:element name=“column” type=“configVariable” minOccurs=“1”
maxOccurs=“unbounded”/>
      </xsd:sequence>
      <xsd:attribute name=“oid” type=“xsd:string” />
      <xsd:attribute name=“parent” type=“xsd:string” />
      <xsd:attribute name=“isSnmpOnly” type=“xsd:boolean” />
      <xsd:attribute name=“snmpStatus” type=“xsd:string” />
      <xsd:attribute name=“snmpClassname” type=“xsd:string” />
  </xsd:complexType>
  <!--
    ==  A configVariableRef is used in events to describe which variables are
contained
    ==  in the event.
    ==
    ==  A variable ref has no attributes or contained elements. It is a single
element
    ==  contianing the name of the variable.
    -->
  <xsd:complexType name=“configVariableRef”>
    <xsd:simpleContent>
          <xsd:extension base=“xsd:string”>
          </xsd:extension>
    </xsd:simpleContent>
  </xsd:complexType>
  <!--
    ==  A config event contains a list of variable-ref objects. These map
    ==  to variables that must be in either groups, tables, or external-var
    ==  definitions.
    ==
    ==  name: The name of the event
    ==  description: The description of the event
    ==  variable-ref: A list of variable names that the event will contain
  -->
  <xsd:complexType name=“configEventType” >
      <xsd:sequence>
          <xsd:element name=“name” type=“xsd:string” />
          <xsd:element name=“description” type=“xsd:string” minOccurs=“0”
maxOccurs=“1”/>
          <xsd:element name=“variable-ref” type=“configVariableRef” minOccurs=“0”
maxOccurs=“unbounded” />
      </xsd:sequence>
      <xsd:attribute name=“oid” type=“xsd:string” />
  </xsd:complexType>
  <!--
    ==  A config schema is an XML document containing lists of the following.
    ==
    ==  mibinfo: A single mibinfo structure
    ==  externalVar: A list of external var definitions. These are variables that
are contained
    ==  in other MIBs but are referenced by the MIB generated from this
schema.
    ==  type: A list of user-defined types
    ==  group: A list of groups
    ==  table: A list of tables
    ==  event: A list of events
  -->
  <xsd:complexType name=“configSchemaType” >
      <xsd:sequence>
          <xsd:element name=“mibinfo” type=“mibInfoType” minOccurs=“0” maxOccurs=“1”
/>
          <xsd:element name=“externalVar” type=“configVariable” minOccurs=“0”
maxOccurs=“unbounded” />
<xsd:element name=“type”  type=“configType” minOccurs=“0”
maxOccurs=“unbounded” />
<xsd:element name=“group”  type=“configGroup” minOccurs=“0”
maxOccurs=“unbounded” />
<xsd:element name=“table”  type=“configTable” minOccurs=“0”
maxOccurs=“unbounded” />
<xsd:element name=“event”  type=“configEventType” minOccurs=“0”
maxOccurs=“unbounded” />
      </xsd:sequence>
  </xsd:complexType>
  <!--
    ==  The top node in the config schema is the ‘config’ node
  -->
  <xsd:element name =“config” type=“configSchemaType” />
</xsd:schema>
```

1. A system for representing network devices, comprising
a data notation, wherein the data notation is in an extended markup language (XML) syntax and wherein the data notation is operable to represent a configuration of a first network device.

2. The system of claim 1, wherein the data notation is operable to represent a configuration of a second network device wherein the configuration of the first device is different than the second device.

3. A method for representing network devices, comprising:
parsing configuration data pertaining to the configuration of a first network device; and
representing the configuration of the first network device in a data notation, wherein the data notation is in an extended markup language (XML) syntax.

4. The method of claim 3, comprising:
parsing configuration data pertaining to the configuration of a second network device; and
representing the configuration of the second network device in the data notation, wherein the configuration data pertaining to the first network device and the configuration data pertaining to the second network device are in different formats.
